(19) United States
(12) Patent Application Publication
(10) Pub. No.: US 2026/0367351 A1
(43) Pub. Date: Nov. 19, 2026

(54) OPTICAL FIBER CABLE HAVING COMPONENTS WITH FLAME-RETARDANT COATINGS AND METHOD OF MAKING SAME

(71) Applicant: CORNING RESEARCH & DEVELOPMENT CORPORATION, Corning, NY (US)

(72) Inventors: Jie Feng, Berlin (DE); Waldemar Stöcklein, Coburg (DE)

(21) Appl. No.: 19/745,160

(22) Filed: Jul. 17, 2026

Related U.S. Application Data
(63) Continuation of application No. PCT/US2025/013160, filed on Jan. 27, 2025.
(60) Provisional application No. 63/549,028, filed on Feb. 2, 2024.

(51) Int. Cl. G02B 6/44

(52) U.S. Cl. CPC G02B 6/4436; G02B 6/443; G02B 6/4486

(57) ABSTRACT

Embodiments of a flame-retardant component of an optical fiber cable are provided. The flame-retardant component includes a component that extends along a length of the optical fiber cable. A coating of a flame-retardant material is disposed on the component. The flame-retardant material includes a flame-retardant compound, and the component does not contain any flame-retardant compound. Also provided are embodiments of an optical fiber cable and a method of forming a flame-retardant component of an optical fiber cable.

### CROSS-REFERENCE TO RELATED APPLICATION

This application is a continuation of International Patent Application No. PCT/US2025/013160, filed on Jan. 27, 2025, which claims the benefit of priority of U.S. Provisional Application No. 63/549,028, filed on Feb. 2, 2024, the content of which is relied upon and incorporated herein by reference in its entirety.

### BACKGROUND

The disclosure relates generally to optical fiber cables and more particularly to components of an optical fiber cable having flame-retardant coatings. Optical fiber cables typically have cable jackets made from a polymeric material. In certain applications, flame-retardant additives may be used in the polymeric material of certain structures within the optical fiber cable. Such flame-retardant cable components may help diminish the effects of a fire or prevent spread when a fire breaks out in a premises. For example, some flame retardants may limit the amount of smoke produced by the fire, and others may limit the ability of the fire to spread along the cable, thereby cutting off one pathway for a fire to spread to multiple rooms of a premises. However, Applicant has found that there are drawbacks associated with utilizing flame-retardant materials within the polymer matrix of optical fiber cable components.

### SUMMARY

In one aspect, embodiments of the present disclosure relate to a flame-retardant component of an optical fiber cable. The flame-retardant component includes a component that extends along a length of the optical fiber cable. A coating of a flame-retardant material is disposed on the component. The flame-retardant material includes a flame-retardant compound, and the component does not contain any flame-retardant compound.

In another aspect, embodiments of the present disclosure relate to an optical fiber cable. The optical fiber cable includes a plurality of components in which at least one component of the plurality of components is coated with a flame-retardant material. The plurality of components includes a cable jacket and at least one optical fiber. The cable jacket has an inner surface and an outer surface. The inner surface defines a central bore extending along a length of the optical fiber cable. The at least one optical fiber is disposed within the central bore. The flame-retardant material includes a flame-retardant compound, and the at least one component does not contain any flame-retardant compound.

In still another aspect, embodiments of the present disclosure relate to a method of preparing a flame-retardant component of an optical fiber cable. In the method, a component of the optical fiber cable is passed through a flame-retardant material. The flame-retardant material coats the component. The flame-retardant material includes a flame-retardant compound, and the component does not include any flame-retardant compound.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. In the drawings:

FIG. 1 depicts an optical fiber cable having one or more components with a flame-retardant coating, according to an exemplary embodiment; and

FIG. 2 is a schematic depiction of a process line for applying the flame-retardant coating to a component of an optical fiber cable, according to an exemplary embodiment.

### DETAILED DESCRIPTION

Referring generally to the following description and appended figures, various embodiments of an optical fiber cable component having a flame-retardant coating as well as a method of preparing same are provided. As will be discussed more fully below, the flame-retardant coating is applied to an optical fiber cable component, such as a cable jacket, a buffer tube, an upjacket of a central strength member, or an optical fiber. Instead of forming these materials from a flame-retardant polymeric compound, such as a polymeric compound containing flame-retardant fillers, the flame-retardant material is coated onto the cable component. In this way, the flame-retardant material is exposed to flames to act immediately during burning. In certain existing cable designs in which the flame-retardant material is dispersed in a polymeric matrix, at least some polymeric matrix will burn before the flame-retardant material can begin acting. This contributes to unnecessary heat generation and potential evolution of undesirable combustion products.

The cable components coated with flame-retardant material according to the present disclosure can be manufactured in a continuous, roll-to-roll process. In particular, the cable component can be paid off from a first roll, passed through a tank of the flame-retardant material, and taken up on a second roll. Additionally, before entering the tank of flame-retardant material, the cable component may be treated to prepare the surface for bonding of the flame-retardant material, and after exiting the tank of flame-retardant material, the cable component may be cured using air, heat, or radiation before being taken up on the second roll. These and other aspects and advantages of the disclosed optical fiber cable containing component with flame-retardant coatings and method of forming same will be described herein and in relation to the figures. Such exemplary embodiments are provided by way of illustration and not by way of limitation.

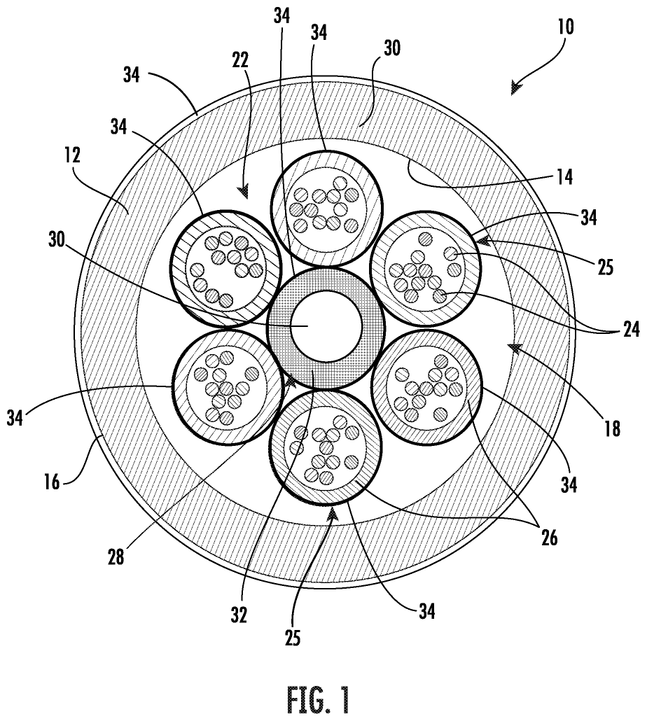

FIG. 1 depicts an exemplary embodiment of an optical fiber cable 10 according to the present disclosure. The optical fiber cable 10 includes a cable jacket 12. The cable jacket 12 includes an inner surface 14 and an outer surface 16. The inner surface 14 defines a central bore 18 of the optical fiber cable 10 that extends along a length of the optical fiber cable 10. In one or more embodiments, the outer surface 16 of the cable jacket 12 is an outermost surface of the optical fiber cable 10 (unless, as discussed below, the cable jacket 12 includes a flame retardant coating 34 in which case the flame retardant coating 34 will be the outermost surface of the optical fiber cable 10).

Disposed within the central bore 18 is a cable core 22. The cable core 22 includes all of the elements within the cable jacket 12 including at least one optical fiber 24. In the embodiment depicted, the optical fibers 24 are divided into subunits 25. In one or more embodiments, the subunits 25 include buffer tubes 26 surrounding one or more optical fibers 24. Further, in one or more embodiments, the buffer tubes 26 may be stranded around a central strength member 28. In one or more embodiments, the central strength member 28 includes a tensile element 30 and an upjacket 32 formed around the tensile element 30. In the embodiment depicted in FIG. 1, six subunits 25 are stranded around the central strength member 28. In one or more embodiments, each of buffer tubes 26 of the subunits 25 contacts the central strength member 28, in particular contacting the upjacket 32. Each subunit 25 in the embodiment depicted contains twelve optical fibers 24 in a loose tube configuration within the buffer tube 26. The embodiment of the optical fiber cable 10 is merely illustrative, and other optical fiber cable constructions are considered to be within the scope of the present disclosure.

In one or more embodiments, the cable core 22 can include anywhere from one to several hundred or even thousands of optical fibers 24. Further, the optical fibers 24 may be in a loose tube or a ribbon configuration within the buffer tubes 26. Additionally, the optical fibers 24 may not be arranged in subunits 25 and may instead be loose within the cable jacket 12 or arranged in ribbons within the cable jacket 12. Still further, the optical fibers 24 may be divided into other subunit structures, such as grouped within binding films or thin membranes. In one or more embodiments, the cable core 22 includes one or more other structures, such as an armor layer; a water-blocking tape, powder, or yarn; strengthening yarns; a binder wrap or film; and a ripcord, among other possibilities.

According to embodiments of the present disclosure, the optical fiber cable 10 includes one or more components, such as the cable jacket 12, the buffer tubes 26, the upjacket 32, or the optical fibers 24, coated with a flame-retardant material. Certain existing optical fiber cable designs include flame-retardant material disposed within cable components, such as flame-retardant fillers dispersed in a polymeric material of the cable jacket, buffer tube, or upjacket. In such existing designs, the polymeric material must burn to some extent before the flame-retardant fillers can be accessed and take effect. Such burning of the polymeric material increases heat generation and, depending on the polymeric material (such as PVC), may undesirably release halogenated compounds. In contrast, by coating the flame-retardant material on the surface of the cable jacket 12, buffer tube 26, upjacket 32, and/or optical fibers 24, among other potential structures, the flame-retardant material is immediately accessible to provide the flame-retardant effect. In one or more such embodiments, the cable component (cable jacket 12, buffer tube 26, upjacket 32, and/or optical fibers 24) may be formed, at least in part, from a polymeric material that does not contain any flame-retardant material.

In one or more embodiments, the flame-retardant material includes flame-retardant compounds, such as minerals, siloxanes, intumescent flame retardants, phosphorus-containing compounds, and nitrogen-containing compounds, amongst other possibilities. These flame-retardant compounds can be one or more compounds from the following given examples, such as aluminum trihydrate, magnesium hydroxide, layered double hydroxides, huntite and hydromagnesite, kaolinite, bentonite, montmorillonite, hydroxyapatite, graphite, graphene oxide, polysiloxane, polyhedral oligomeric silsesquioxanes, intumescent flame retardant (a typical system includes pentaerythritol, ammonium polyphosphate, and melamine), polyphosphoric acid, sodium hexametaphosphate, phytic acid, poly(sodium phosphate), phosphorylated cellulose, polyhexamethylene guanidine phosphate, poly(vinylphosphonic acid), chitosan, poly(ethyleneimine), N-2-(5,5-dimethyl-1,3,2-dioxaphosphinyl-2-ylamino)-ethylacetamide-2-propenyl acid, and nitrogen-modified silane, amongst other possibilities. In one or more embodiments, the flame-retardant material does not include organic halogen compounds that may release halogenated gas upon decomposition.

In one or more embodiments, the coating of flame-retardant material is bound to the optical fiber cable component through Van der Waals forces, static electric charges, or a small amount of polymeric binder. In one or more embodiments, the surface of the cable component is prepared for coating through a surface activation treatment designed to make the surface of the component receptive to the coating of flame-retardant material, e.g., by generating polarization, building up static electric charge, producing radicals, or producing hydroxyl groups, amongst other possibilities. Suitable surface activation treatments include acid etching, corona treatment, flame treatment, or low temperature plasma treatment, amongst other possibilities. In one or more embodiments, the surface of the cable component is prepared for coating by applying (e.g., spraying, dip-coating, brushing, etc.) a polymeric binder on the surface of the cable component. In one or more embodiments, the polymeric binder is at least one of an acrylic, a carboxymethylcellulose, an alginate, a polyurethane, or a styrene butadiene copolymer. Additionally, in one or more embodiments, the cable component may undergo multiple surface preparation steps, such as a corona treatment followed by application of a polymeric binder.

After the surface of the cable component is prepared, the cable component is passed through the flame-retardant material to coat the flame-retardant material on the cable component. As shown in FIG. 1, the outer surface 16 of the cable jacket 12 is covered with a flame-retardant coating 34, the upjacket 32 is covered with a flame-retardant coating 34, and each of the buffer tubes 26 is covered with a flame-retardant coating 34. Additionally, the flame-retardant coating 34 can be applied to one or more of the optical fibers 24 in the buffer tubes 26. However, in one or more other embodiments, the flame-retardant coating 34 may only be provided on one such cable component or less than all such cable components.

In one or more embodiments, the flame-retardant coating 34 has a first thickness that is less than a second thickness of the component of the optical fiber cable. In one or more embodiments, the flame-retardant coating has a thickness in a range from 0.01 μm to 10 μm per mm of thickness of the cable component, in particular in a range from 0.05 μm to 2 μm per mm of thickness of the cable component. For the cable jacket 12, the buffer tubes 26, and the upjacket 32, the thickness of the cable component refers to the wall thickness (e.g., distance between inner surface 14 and outer surface 16 of the cable jacket 12), whereas for the optical fiber 24, the thickness of the cable component refers to the outer diameter of the optical fiber 24.

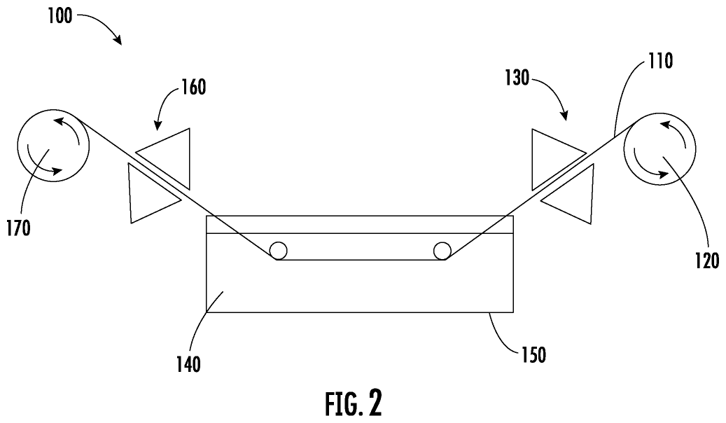

FIG. 2 depicts a schematic diagram of a process line 100 for preparing an optical fiber cable 10 having one or more cable components with a flame-retardant coating 34. In one or more embodiments, the process line 100 is a roll-to-roll process. In one or more such embodiments, a cable component 110 is paid off from a first roll 120. The cable component 110 may be an optical fiber cable 10, such that the cable jacket 12 is coated on the process line 100. The cable component 110 may be a buffer tube 26 containing one or more optical fibers 24. The cable component 110 may be a central strength member 28 having an upjacket 32 around a tensile element 30. Still further, the cable component 110 may be an optical fiber 24. In one or more embodiments, the cable component 110 paid off of the first roll 120 passes through a surface preparation station 130. As discussed above, the surface preparation station 130 may treat the surface of the cable component 110, e.g., using a plasma corona or by spraying binder material onto surface of the cable component 110, to make the surface of the component receptive to the coating of flame-retardant material 140.

After passing through the surface preparation station 130, the cable component 110 is immersed in the flame-retardant material 140. As shown in FIG. 2, the flame-retardant material 140 is contained in a tank 150, and the cable component 110 is passed through the tank 150 so that the flame-retardant material 140 can bond to the surface of the cable component 110. In one or more embodiments, the flame-retardant material may be in the form of a water-based dispersion, e.g., containing water, the flame-retardant material, and a binder. For example, the water-based dispersion may contain 30 wt % to 60 wt % water, 30 wt % to 60 wt % of flame-retardant compound, and up to 30 wt % of a binder. In embodiments employing water- and other liquid-based dispersions, the flame-retardant material and/or binder may need to be dried or cured after being applied to the cable component 110. Thus, in one or more embodiments, the cable component 110 passes through a curing station 160. In the curing station 160, the flame-retardant material may be exposed to heat, forced air, or radiation (e.g., ultraviolet or infrared). Thereafter, the cable component 110 having the flame-retardant coating applied thereon may be taken up on a second roll 170. The second roll 170 can undergo further processing (e.g., forming of a cable core 22 around which a cable jacket 12 is extruded) or stored for later use.

In one or more embodiments, the flame-retardant coating 34 is substantially conformal and continuous along the length of the cable component 110. Further, the coating 34 forms a bond sufficient with the cable component that the coating 34 does not flake off or strip from the cable component 110 during typical handling, cable assembly, and cable routing activities.

### Experimental Embodiment

Sample cables were prepared according to the present disclosure and subjected to multi-cable burn testing according to the Construction Products Regulation (CPR) EN 50399. In particular, four cables were prepared according to the present disclosure (inventive cables I1-I4) including a 2.0 mm thick flame-retardant, non-corrosive (FRNC) polymer (ConGUARD 6650S) cable jacket 12 surrounding six buffer tubes 26 formed from polycarbonate (PC) and polybutylene terephthalate (PBT) composites. All six buffer tubes 26 were coated with flame-retardant material applied via a water-based dispersion containing 5 wt % kaolin, 45 wt % ammonium polyphosphate (APP), 15 wt % acrylic binder, and the balance water. The buffer tubes 26 had an outer diameter of 2.3 mm, and with the flame-retardant coating 34, the buffer tubes 26 had an outer diameter of 2.6 mm. The buffer tubes 26 were stranded around a central strength member 28 including only a glass-reinforced plastic (GRP) tensile strength member 30 without an upjacket 32. The buffer tubes 26 each contained twelve optical fibers 24.

Two comparative cables (C5 and C6) were prepared according to existing designs. In particular, the comparative cables included a 2.0 mm thick FRNC cable jacket surrounding six buffer tubes stranded around a GRP central strength member. The buffer tubes were PC/PBT composite without a flame-retardant coating, and the buffer tubes had an outer diameter of 2.6 mm. The comparative cables also included twelve optical fibers 24 in each buffer tube.

Table 1, below, summarizes the results of the multi-cable burn testing.

TABLE 1
Burn Performance of Inventive Cables Compared to Cables of an Existing Design

| | FS | PHRR | FIGRA | PSPR | TSP | Droplets | Droplets | |
|---|---|---|---|---|---|---|---|---|
| Sample | (m) | (kW) | (W/s) | (m²/s) | (m²) | t ≤ 10 s | T ≥ 10 s | Rating |
| I1 | 2.29 | 35.9 | 81 | 0.09 | 66 | N | N | Dcas2d0 |
| I2 | 1.44 | 28.1 | 72 | 0.09 | 43 | N | N | B2cas1d0 |
| I3 | 1.11 | 19.2 | 71 | 0.10 | 26 | N | N | B2cas1d0 |
| I4 | 2.41 | 37.4 | 89 | 0.09 | 63 | N | N | Dcas2d0 |
| C5 | 3.30 | 137.1 | 135 | 0.59 | 238 | Y | Y | Eca |
| C6 | 2.85 | 40.4 | 82 | 0.15 | 116 | Y | Y | Dcas2d2 |

FS = Flame Spread
PHRR = Peak Heat Release Rate
FIGRA = Fire Growth Rate
PSPR = Peak Smoke Release Rate
TSP = Total Smoke Production

As can be seen from Table 1, the sample cables according to the present disclosure (cables I1-I4) all performed better overall than the existing cable designs (cables C5 and C6). In particular, flame spread was reduced to less than 3 m, in particular less than 2.5 m. Peak heat release rate was reduced to less than 40 kW, and fire growth rate was on average lower for the inventive cables than for the comparative cables. Further, both the rate of smoke production and the amount of smoke produced were much lower for the inventive cables than for the comparative cables. Additionally, the inventive cables did not produce any flaming droplets, whereas the comparative cables produced flame droplets quickly upon burning (droplets present after less than 10 seconds) and after burning for a while (droplets present 10 seconds or later). Accordingly, the inventive cables were rated higher under the CPR as evaluated according to EN 50399.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein the article “a” is intended include one or more than one component or element, and is not intended to be construed as meaning only one.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A flame-retardant component of an optical fiber cable, comprising:
a component extending along a length of the optical fiber cable;
a coating of a flame-retardant material disposed on the component;
wherein the flame-retardant material comprises a flame-retardant compound and wherein the component does not contain any flame-retardant compound.

2. The component of claim 1, wherein the flame-retardant compound comprises at least one of aluminum trihydrate, magnesium hydroxide, layered double hydroxides, huntite and hydromagnesite, kaolinite, bentonite, montmorillonite, hydroxyapatite, graphite, graphene oxide, polysiloxane, polyhedral oligomeric silsesquioxanes, intumescent flame retardant (a typical system includes pentaerythritol, ammonium polyphosphate, and melamine), polyphosphoric acid, sodium hexametaphosphate, phytic acid, poly(sodium phosphate), phosphorylated cellulose, polyhexamethylene guanidine phosphate, poly(vinylphosphonic acid), chitosan, poly(ethyleneimine), N-2-(5,5-dimethyl-1,3,2-dioxaphosphinyl-2-ylamino)-ethylacetamide-2-propenyl acid, or nitrogen-modified silane.

3. The flame-retardant component of claim 1, wherein the flame-retardant compound is bound to the component through Van der Waals forces.

4. The flame-retardant component of claim 1, wherein the flame-retardant compound is bound to the component through static electric charge.

5. The flame-retardant component of claim 1, wherein the flame-retardant compound is bound to the component through a polymeric binder.

6. The flame-retardant component of claim 5, wherein the polymeric binder comprises at least one of an acrylic, a carboxymethylcellulose, an alginate, a polyurethane, or a styrene butadiene copolymer.

7. The flame-retardant component of any of claim 1, wherein the coating has a first thickness and the component has a second thickness, the first thickness being less than the second thickness.

8. The flame-retardant component of claim 7, wherein the first thickness is in a range from 0.01 μm to 10 μm per mm of the second thickness.

9. The flame-retardant component of claim 1, wherein the component is at least one of a cable jacket, a buffer tube, an upjacket of a central strength member, or an optical fiber.

10. An optical fiber cable, comprising:
a plurality of components, at least one component of the plurality of components being coated with a flame-retardant material;
wherein the plurality of components comprises a cable jacket and at least one optical fiber;
wherein the cable jacket comprises an inner surface and an outer surface, the inner surface defining a central bore extending along a length of the optical fiber cable;
wherein the at least one optical fiber is disposed within the central bore; and
wherein the flame-retardant material comprises a flame-retardant compound and wherein the at least one component does not contain any flame-retardant compound.

11. The optical fiber cable of claim 10, wherein the optical fiber cable does not produce any flaming droplets when tested according to EN 50399.

12. A method of preparing a flame-retardant component of an optical fiber cable, the method comprising:
passing a component of the optical fiber cable through a flame-retardant material;
wherein the flame-retardant material coats the component;
wherein the flame-retardant material comprises a flame-retardant compound; and
wherein the component does not comprise any flame-retardant compound.

13. The method of claim 12, wherein passing the component through the flame-retardant material further comprises passing the component through a liquid-based dispersion comprising the flame-retardant material.

14. The method of claim 13, wherein the liquid-based dispersion comprises 30 wt % to 60 wt % of the flame-retardant compound and up to 30 wt % of a binder.

15. The method of claim 12, further comprising passing the component through a surface preparation station before passing the component through the flame-retardant material.

16. The method of claim 15, wherein the surface preparation station applies a corona treatment to a surface of the component.

17. The method of claim 15, wherein the surface preparation station applies a polymeric binder to a surface of the component.

18. The method of claim 12, further comprising passing the component through a curing station after passing the component through the flame-retardant material.

19. The method of claim 18, wherein the curing station applies air, heat, or radiation to the flame-retardant material.

20. The method claim 12, further comprising the steps of:
paying the component off of a first roll prior to passing the component through the flame-retardant material; and
taking the component up on a second roll after passing the component through the flame-retardant material.
